(19) United States
(12) Patent Application Publication
(10) Pub. No.: US 2023/0169060 A1
(43) Pub. Date: Jun. 1, 2023

(54) Server and Control Method Thereof

(71) Applicants: Kia Corporation, Seoul (KR); Hyundai Motor Company, Seoul (KR)

(72) Inventors: Jae Yul Woo, Seoul (KR); Soobin Kim, Seoul (KR); Seunghyun Woo, Seoul (KR); Rowoon An, Seoul (KR)

(21) Appl. No.: 18/056,592

(22) Filed: Nov. 17, 2022

(30) Foreign Application Priority Data
Nov. 29, 2021 (KR) 10-2021-0166579

(51) Int. Cl. G06F 16/23; H04L 67/52

(52) U.S. Cl. CPC G06F 16/23; H04L 67/52

(57) ABSTRACT

In an embodiment a server includes a communicator and a controller configured to update a database for a point of interest stored in advance with point of interest information when receiving the point of interest information and link information from a user terminal through the communicator and control the communicator to transmit the link information and a reward request for a user of the user terminal to an external server, wherein the link information is information on an identification code assigned to the user of the user terminal.

### CROSS-REFERENCE TO RELATED APPLICATIONS

This application claims the benefit of U.S. Provisional Application No. 10-2021-0166579, filed on Nov. 29, 2021, which application is hereby incorporated herein by reference.

### TECHNICAL FIELD

The disclosure relates to a server providing a crowd sourcing service and a control method thereof.

### BACKGROUND

Because information on a point of interest (POI) used in map and navigation services may change flexibly with the passage of time and the period thereof is not fixed, it is difficult for existing service providers to keep up-to-date data.

Existing service providers are updating their database for information on a point of interest through their own information acquisition process on the point of interest, which may be difficult to respond to a speed of change in point of interest.

Therefore, it may be difficult for a user to access up-to-date information for a point of interest, and the user may have no choice but to evaluate the point of interest based on previous information.

### SUMMARY

Embodiments provide a server capable of updating a database with an up-to-date point of interest (POI) through crowd sourcing and providing rewards to crowd sourcing participants even without exposing personal information, and a control method thereof.

In accordance with an embodiment of the disclosure, a server includes a communicator, and a controller configured to update a database for a point of interest (POI) stored in advance with point of interest information when receiving the point of interest information and link information from a user terminal through the communicator, and control the communicator to transmit the link information and a reward request for a user of the user terminal to an external server, wherein the link information is information on an identification code assigned to the user of the user terminal.

The controller may determine accuracy of the point of interest information when receiving the point of interest information from the user terminal, and update the database for the point of interest when the accuracy of the point of interest information is equal to or greater than a predetermined value.

The controller may determine the accuracy of the point of interest information based on an output of a neural network for the point of interest information, and the neural network may be learned based on the point of interest information depending on the business type of the point of interest.

The controller may control the communicator to transmit the point of interest information to the external server, and determine the accuracy of the point of interest information with information received from the external server.

The controller may control the communicator to transmit the updated database for the point of interest to the external server.

The controller may identify the user of the user terminal based on the link information and provides a reward for an account of the user.

The point of interest information may include information in the form of at least one of a picture, a video, and a text for the corresponding point of interest.

The point of interest information may include at least one of review information, business type information, name information, location information, travel route information, contact information, and business information of the corresponding point of interest.

In accordance with another embodiment of the disclosure, a control method of a server, which includes a communicator, includes updating a database for a point of interest stored in advance with the point of interest information when receiving point of interest (POI) information and link information from a user terminal through the communicator, and controlling the communicator to transmit the link information and a reward request for a user of the user terminal to an external server, wherein the link information is information on an identification code assigned to the user of the user terminal.

The control method may further include determining accuracy of the point of interest information when receiving the point of interest information from the user terminal, and updating the database for the point of interest when the accuracy of the point of interest information is equal to or greater than a predetermined value.

The determining of the accuracy of the point of interest information may include determining the accuracy of the point of interest information based on an output of a neural network for the point of interest information, wherein the neural network may be learned based on the point of interest information depending on the business type of the point of interest.

The determining of the accuracy of the point of interest information may include controlling the communicator to transmit the point of interest information to the external server, and determining the accuracy of the point of interest information with information received from the external server.

The control method may further include controlling the communicator to transmit the updated database for the point of interest to the external server.

The control method may further include identifying the user of the user terminal based on the link information, and providing a reward for an account of the user.

The point of interest information may include information in the form of at least one of a picture, a video, and a text for the corresponding point of interest.

The point of interest information may include at least one of review information, business type information, name information, location information, travel route information, contact information, and business information of the corresponding point of interest.

In accordance with yet another embodiment of the disclosure, a point of interest information crowd sourcing system includes a plurality of user terminals, and a server provided to perform communication with the plurality of user terminals, wherein the server updates a database for a point of interest (POI) stored in advance with point of interest information when receiving the point of interest information from at least one of the plurality of user terminals and information on an identification code assigned to a user of the at least one user terminal.

### BRIEF DESCRIPTION OF THE DRAWINGS

These and/or other embodiments of the disclosure will become apparent and more readily appreciated from the following description of the embodiments, taken in conjunction with the accompanying drawings of which:

FIG. 1 illustrates a system for crowd sourcing points of interest (POI) information according to an embodiment;

FIG. 2 is a control block diagram of a server according to an embodiment;

FIG. 3 is a signal flow diagram when the server updates a database of point of interest information through the crowd sourcing according to an embodiment;

FIG. 4 illustrates a case in which the server receives the point of interest information and link information from a user terminal according to an embodiment;

FIG. 5 illustrates a case in which the server updates the database using the point of interest information and determines a reward provision according to an embodiment; and

FIG. 6 is a flowchart illustrating a case in which the database of the point of interest information is updated and the reward provision is determined in a control method of the server according to an embodiment.

### DETAILED DESCRIPTION OF ILLUSTRATIVE EMBODIMENTS

Throughout the specification, like reference numerals refer to like elements. This specification does not describe all the elements of the embodiments, and duplicative contents between general contents or embodiments in the technical field of the present disclosure will be omitted.

Throughout this specification, when a portion is “connected” to another portion, this includes the case in which the portion is indirectly connected to the other portion, as well as the case in which the portion is directly connected to the other portion, and the indirect connection includes a connection through a wireless communication network.

When it is described that a part “includes” an element, it means that the element may further include other elements, not excluding the other elements unless specifically stated otherwise.

The singular expression includes the plural expression unless the context clearly dictates otherwise.

Terms such as “˜unit”, “˜part,” “˜block,” “˜member,” “˜module,” and the like may denote a unit for processing at least one function or operation. For example, the terms may refer to at least one hardware such as a field-programmable gate array (FPGA)/an application specific integrated circuit (ASIC), at least one software stored in a memory, or at least one process processed by a processor.

Identification numerals assigned to steps are used to identify the steps, the identification numerals do not indicate the order of the steps, and each step may be performed differently from the specified order unless the context clearly indicates a specific order.

Hereinafter, embodiments of a server and a control method thereof will be described in detail with reference to the accompanying drawings.

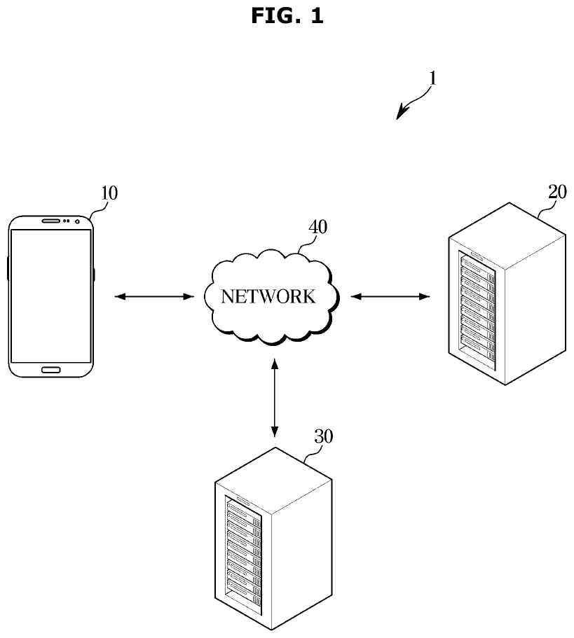

FIG. 1 illustrates a system for crowd sourcing point of interest (POI) information according to an embodiment.

Referring to FIG. 1, a point of interest information crowd sourcing system 1 according to an embodiment includes a user terminal 10 provided to determine points of interest information, a server 20 provided to update a database for a point of interest based on the point of interest information received from the user terminal 10, a reward providing server 30 provided to provide a reward for an account of a user of the user terminal 10 in response to a request of the server 20, and a network 40 provided to support communication between the user terminal 10, the server 20, and the reward providing server 30.

The user of the user terminal 10 may generate point of interest information in the form of at least one of a picture, a video, and a text. That is, the user terminal 10 may determine the point of interest information based on information on a point of interest input from the user (inputting text or photographing the point of interest). In this case, the user may be a consumer who uses the point of interest or a delivery company that performs delivery from the point of interest.

In this case, the point of interest may correspond to stores of various business types such as restaurants, cafes, and grocery stores. However, the type of point of interest is not limited to a store, and there is no limitation as long as it is a place such as a tourist destination and a government office.

In addition, the point of interest information may include at least one of review information, business type information, name information, location information, travel route information, contact information, and business information of the corresponding point of interest.

The server 20 according to an embodiment may receive the point of interest information from the user terminal 10, may update a database for the point of interest through this, and provide a map service or a navigation service that provides point of interest information based on an up-to-date database. In addition, the server 200 may provide the up-to-date database by transmitting the up-to-date database to a server of another company that provides the map service, according to an embodiment.

The server 20 according to an embodiment may receive the point of interest information from the user terminal 10 and at the same time, receive link information that is an identification code for the user of the user terminal 10. The link information does not include personal information of the user (contact information, resident registration number, name, etc.), and may include only the identification code assigned to the user. Through this, there is no risk of exposing the personal information of the user even when the link information is transmitted and received on the network 40, and the link information is shared between subjects performing communication, so that a communication subject may identify the user through the link information. For example, the link information is a value (identification code) obtained by encrypting the resident registration number with 88 bytes, and the same value may be assigned to the user regardless of a businessperson.

The server 20 according to an embodiment may transmit link information to the reward providing server 30, and the reward providing server 30 may identify the user of the user terminal 10 who uploads point of interest information based on the link information and provide a reward (e.g., points, coins, cash, authentication, ranking, etc.) to the account of the user.

For example, the reward providing server 30 may be a server of a delivery agency that provides a delivery service, and the delivery agency may provide a reward to the user (e.g., a rider registered with the delivery agency) of the user terminal 10 that provides the point of interest information.

In addition, the server 20 may provide a reward to the user of the user terminal 10 from the server 20 itself, according to an embodiment.

Each of the user terminal 10, the server 20, and the reward providing server 30 may access the network 40 through wired communication or wireless communication to transmit/receive data to and from another subject.

The configuration of the point of interest information crowd sourcing system 1 has been described above. Hereinafter, the configuration of the server 20 that performs crowd sourcing of point of interest information will be described in detail.

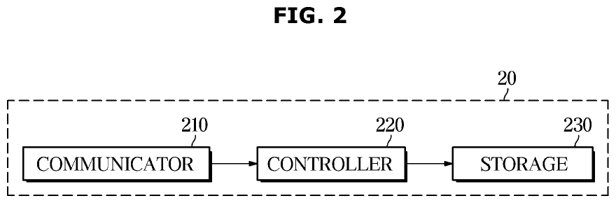

FIG. 2 is a control block diagram of the server 20 according to an embodiment.

Referring to FIG. 2, the server 20 according to an embodiment may include a communication device (communicator) 210 provided to perform communication with an external electronic device, a controller 220 provided to update the database based on the point of interest information received from the user terminal 10 and provide a reward to the user of the user terminal 10, and a storage device 230 provided to store various types of information of information necessary to provide a crowd sourcing service, the map service, the navigation service, etc., such as a database for a point of interest.

The communication device 210 according to an embodiment may transmit/receive data to and from an external electronic device. To this end, the communication device 210 may be provided as a communication module of a known type, and the communication module may connect to the network 40 to exchange data with another communication subject.

The controller 220 according to an embodiment may, when receiving point of interest information and link information from the user terminal 10, update the database for the point of interest based on the point of interest information, and transmit the link information to the reward providing server 30.

The controller 220 according to an embodiment may determine accuracy of point of interest information when receiving the point of interest information from the user terminal 10, and perform an operation of updating the database and an operation of transmitting the link information only when the accuracy is equal to or greater than a set value.

The controller 220 may determine the accuracy of the point of interest information depending on the intervention of a manager of the server 20, according to an embodiment.

According to an embodiment, the controller 220 may control the communication device 210 to transmit point of interest information to an external server, and determine the accuracy of the point of interest information based on information received from the external server. In this case, the external server may be a server of a company that determines the accuracy of the point of interest information, and correspond to the database that stores the point of interest information.

According to an embodiment, the controller 220 may determine the accuracy of the point of interest information based on an output of a neural network for the point of interest information. In this case, the neural network may be stored in the storage device 230, and may be learned based on the point of interest information depending on a business type of the point of interest. That is, the neural network may be supervised learning by inputting point of interest information matching the business type of the point of interest.

Because the aforementioned neural network refers to machine learning in the shape of a neural structure capable of performing deep learning, the neural network improves the reliability of learning by continuously changing a weight and a bias corresponding to the configuration of the neural network. That is, the neural network may improve an inference result of the neural network by continuously updating the weight, the bias, and an activation functions included in the neural network based on the point of interest information specified depending on the business type of the point of interest.

The neural network may include a convolutional neural network (CNN) that generates a feature map output by convolution of driving data and inputs the feature map to the neural network, but is not limited thereto, and may be performed with other deep learning algorithms, including recurrent neural networks (RNNs). That is, there is no limit to the type of neural network.

In addition, the controller 220 according to an embodiment may identify the user of the user terminal 10 using link information and provide a reward to an account of the corresponding user by itself.

The controller 220 according to an embodiment may provide the crowd sourcing service, the map service, or the navigation service using the updated database, and provide the updated database to the outside by controlling the communication device 210 to transmit the updated database to an external company server.

The controller 220 may include at least one memory in which a program for performing the above-described operation and an operation to be described later is stored and at least one processor for executing the stored program. When a plurality of the memories and processors is provided, they may be integrated into one chip, or may be provided in physically separate locations.

The storage device 230 according to an embodiment may store various types of information required for control. For example, the storage device 230 may store a neural network for determining the accuracy of point of interest information, and store a database for the point of interest. To this end, the storage device 230 may be provided as a known type of storage medium.

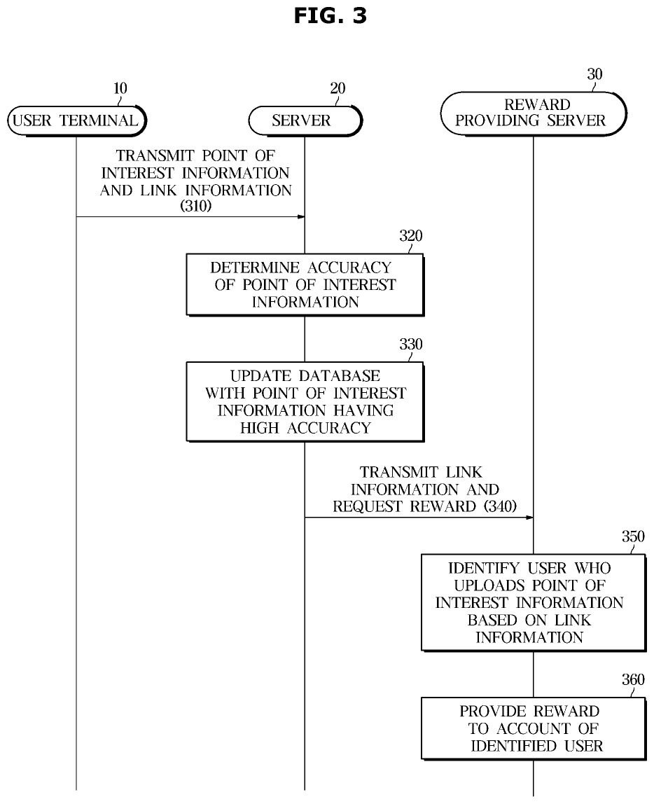

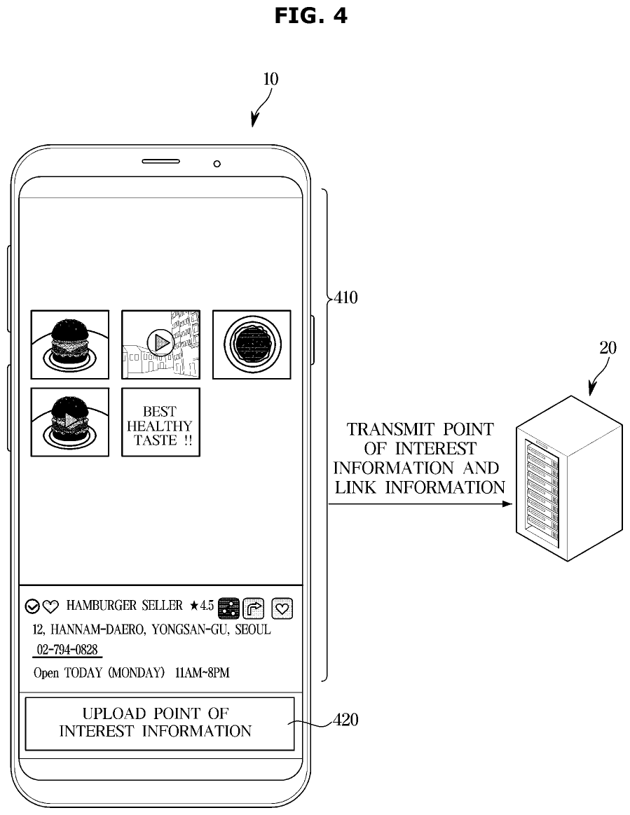

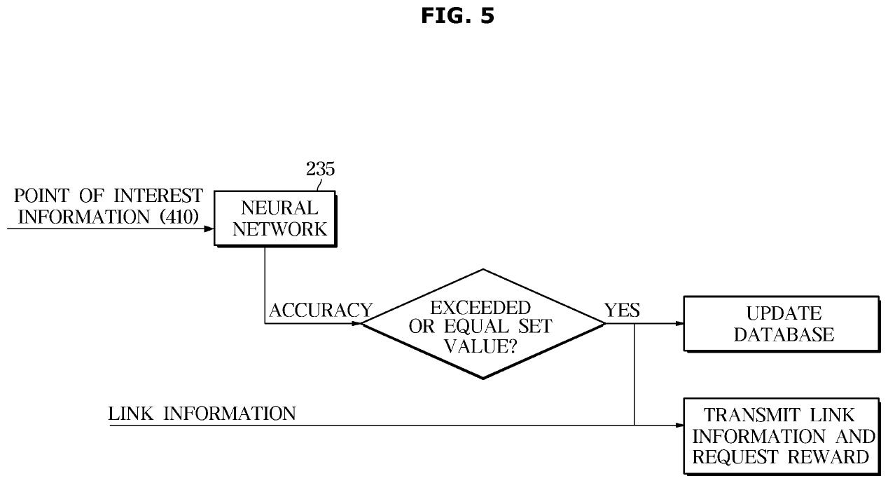

FIG. 3 is a signal flow diagram when the server 20 updates a database of point of interest information through the crowd sourcing according to an embodiment, and FIG. 4 illustrates a case in which the server 20 receives the point of interest information and link information from 20 user terminal 10 according to an embodiment, and FIG. 5 illustrates a case in which the server 20 updates the database using the point of interest information and determines a reward provision according to an embodiment.

Referring to FIGS. 3 to 5, the user terminal 10 according to an embodiment may transmit point of interest information and link information to the server 20 (310).

As illustrated in FIG. 4, the user of the user terminal 10 may generate point of interest information 410 in the form of at least one of a picture, a video, and a text. That is, the user terminal 10 may determine the point of interest information 410 based on the information on the point of interest input from the user (inputting text or photographing a point of interest). In this case, the user may be a consumer who uses the point of interest or a delivery company that performs delivery from the point of interest.

In this case, the point of interest may correspond to stores of various business types such as restaurants, cafes, and grocery stores. However, the type of point of interest is not limited to a store, and there is no limitation as long as it is a place such as a tourist destination and a government office.

In addition, the point of interest information 410 may include at least one of review information, business type information, name information, location information, travel route information, contact information, and business information of the corresponding point of interest.

The user terminal 10 may transmit the point of interest information 410 and the link information of the user to the server 20 when receiving an input for uploading the point of interest information 410 from the user (e.g., touching point of interest information upload button 420).

The link information does not include personal information of the user (contact information, resident registration number, name, etc.), and may include only the identification code assigned to the user. Through this, there is no risk of exposing the personal information of the user even when the link information is transmitted and received on the network 40, and the link information is shared between subjects performing communication, so that a communication subject may identify the user through the link information.

The server 20 according to an embodiment may determine the accuracy of the point of interest information 410 (320), and update the database with the point of interest information 410 having a high accuracy (330).

That is, the server 20 may determine the accuracy of the point of interest information when receiving the point of interest information from the user terminal 10, and perform the operation of updating the database and the operation of transmitting the link information only when the accuracy is equal to or greater than the set value.

For example, as illustrated in FIG. 5, the server 20 may determine the accuracy of the point of interest information based on an output of a neural network 235 for the point of interest information. In this case, the neural network 235 may be stored in the storage device 230, and may be learned based on the point of interest information depending on the business type of the point of interest. That is, the neural network 235 may be supervised learning by inputting point of interest information matching the business type of the point of interest.

Specifically, the server 20 may update the database by determining that the accuracy of the point of interest information is high when accuracy information that is the output of the neural network 235 to which the point of interest information is input is greater than or equal to a predetermined value.

In addition, the server 20 may determine the accuracy of the point of interest information by various methods other than the neural network 235. For example, according to an embodiment, the server 20 may determine the accuracy of the point of interest information depending on the intervention of the manager of the server 20. In addition, according to an embodiment, the server 20 may control the communication device 210 to transmit the point of interest information to an external server, and determine the accuracy of the point of interest information based on information received from the external server. In this case, the external server may be a server of a company that determines the accuracy of the point of interest information.

However, according to an embodiment, the server 20 may update the database for the point of interest based on the reception of the point of interest information without a separate accuracy determination procedure.

The server 20 according to an embodiment may transmit link information to the reward providing server 30 after updating the database, and request a reward (340).

The reward providing server 30 may identify the user of the user terminal 10 who uploads point of interest information based on the link information (350), and provide the reward (e.g., points, coins, cash, authentication, ranking, etc.) to the account of the identified user (360).

For example, the reward providing server 30 may be a server of a delivery agency that provides a delivery service, and the delivery agency may provide the reward to the user (e.g., a rider registered with the delivery agency) of the user terminal 10 that provides the point of interest information.

The server 20 according to an embodiment may identify the user of the user terminal 10 using link information and provide the reward to an account of the corresponding user by itself.

The server 20 according to an embodiment may provide the crowd sourcing service, the map service, or the navigation service using the updated database, and provide the updated database to the outside by controlling the communication device 210 to transmit the updated database to an external company server.

Hereinafter, an embodiment of a control method of the server 20 will be described. The server 20 according to the above-described embodiment may be used in the control method of the server 20. Accordingly, the contents described above with reference to FIGS. 1 to 5 may be equally applied to the control method of the server 20.

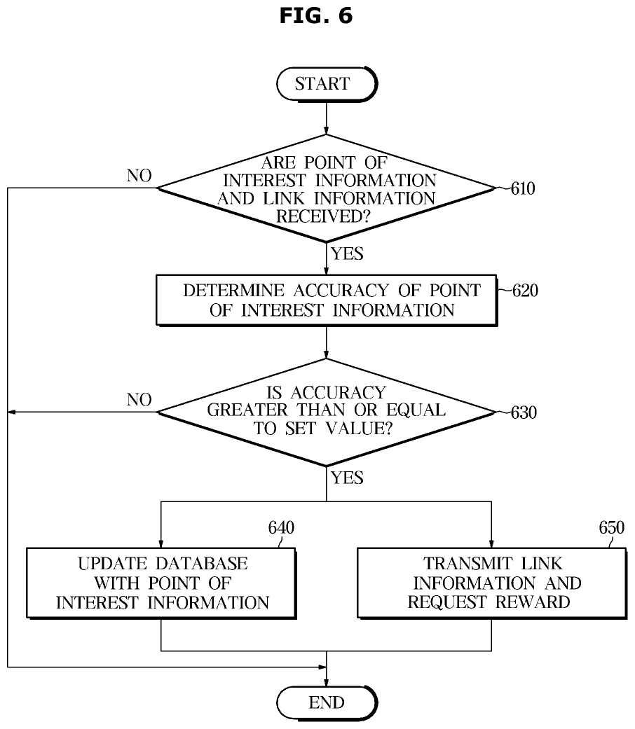

FIG. 6 is a flowchart illustrating a case in which the database of the point of interest information 410 is updated and the reward provision is determined in a control method of the server 20 according to an embodiment.

Referring to FIG. 6, the server 20 according to an embodiment may determine the accuracy of point of interest when receiving the point of interest information and link information (YES in 610) (620), update the database with the point of interest information 410 when the accuracy is greater than or equal to the set value (YES in 630) (640), and request a reward by transmitting the link information (650).

Specifically, the server 20 may update the database for the point of interest based on the point of interest information when receiving the point of interest information and link information from the user terminal 10, and transmit the link information to the reward providing server 30.

According to an embodiment, the server 20 may determine the accuracy of the point of interest information when receiving the point of interest information from the user terminal 10, and perform the operation of updating the database and the operation of transmitting the link information only when the accuracy is equal to or greater than the set value.

As such, the server 20 according to the disclosure may collect points of interest information through crowd sourcing without the intervention of a provider of the server 20, and induce participation in crowd sourcing by providing a reward to a user who provides point of interest information.

In particular, the transmission and reception of personal information of the user on the network is prevented by using user link information to provide a reward for crowd sourcing, so that leakage of the personal information of the user may be minimized.

As is apparent from the above, according to embodiments of a server and a control method thereof, by updating a database with an up-to-date point of interest (POI) through crowd sourcing and providing rewards to crowd sourcing participants even without exposing personal information, a participation rate of crowd sourcing can be increased even without exposing personal information, and the database for the up-to-date point of interest (POI) can be provided.

The disclosed embodiments may be implemented in the form of a recording medium storing instructions executable by a computer. The instructions may be stored in the form of program code, and when executed by a processor, a program module may be created to perform the operations of the disclosed embodiments. The recording medium may be implemented as a computer-readable recording medium.

The computer-readable recording medium includes any type of recording medium in which instructions readable by the computer are stored. For example, the recording medium may include a read only memory (ROM), a random access memory (RAM), a magnetic tape, a magnetic disk, a flash memory, an optical data storage device, and the like.

The embodiments disclosed with reference to the accompanying drawings have been described above. It will be understood by those skilled in the art that various changes in form and details may be made therein without departing from the spirit and scope of the disclosure as defined by the appended claims. The disclosed embodiments are illustrative and should not be construed as limiting.

What is claimed is:

1. A server comprising:
a communicator; and
a controller configured to:
update a database for a point of interest stored in advance with point of interest information when receiving the point of interest information and link information from a user terminal through the communicator, and
control the communicator to transmit the link information and a reward request for a user of the user terminal to an external server,
wherein the link information is information on an identification code assigned to the user of the user terminal.

2. The server according to claim 1, wherein the controller is configured to:
determine accuracy of the point of interest information when receiving the point of interest information from the user terminal, and update the database for the point of interest when the accuracy of the point of interest information is equal to or greater than a predetermined value.

3. The server according to claim 2, wherein the controller is configured to determine the accuracy of the point of interest information based on an output of a neural network for the point of interest information, and wherein the neural network is trained based on the point of interest information depending on a business type of the point of interest.

4. The server according to claim 2, wherein the controller is configured to:
control the communicator to transmit the point of interest information to the external server, and
determine the accuracy of the point of interest information with information received from the external server.

5. The server according to claim 1, wherein the controller is configured to control the communicator to transmit the updated database for the point of interest to the external server.

6. The server according to claim 1, wherein the controller is configured to:
identify the user of the user terminal based on the link information, and
provide a reward for an account of the user.

7. The server according to claim 1, wherein the point of interest information comprises information in form of at least one of a picture, a video, or a text for a corresponding point of interest.

8. The server according to claim 7, wherein the point of interest information comprises at least one of review information, business type information, name information, location information, travel route information, contact information, or business information of the corresponding point of interest.

9. A method for controlling a server, the method comprising:
updating a database for a point of interest stored in advance with point of interest information when receiving the point of interest information and link information from a user terminal through a communicator of the server; and
controlling the communicator to transmit the link information and a reward request for a user of the user terminal to an external server,
wherein the link information is information comprising an identification code assigned to the user of the user terminal.

10. The method according to claim 9, further comprising:
determining accuracy of the point of interest information when receiving the point of interest information from the user terminal; and
updating the database for the point of interest when the accuracy of the point of interest information is equal to or greater than a predetermined value.

11. The method according to claim 10,
wherein determining the accuracy of the point of interest information comprises determining the accuracy of the point of interest information based on an output of a neural network for the point of interest information, and
wherein the neural network is trained based on the point of interest information depending on a business type of the point of interest.

12. The method according to claim 10, wherein determining the accuracy of the point of interest information comprises:
controlling the communicator to transmit the point of interest information to the external server, and
determining the accuracy of the point of interest information with information received from the external server.

13. The method according to claim 9, further comprising controlling the communicator to transmit the updated database for the point of interest to the external server.

14. The method according to claim 9, further comprising:
identifying the user of the user terminal based on the link information; and
providing a reward for an account of the user.

15. The method according to claim 9, wherein the point of interest information comprises information in form of at least one of a picture, a video, or a text for a corresponding point of interest.

16. The method according to claim 15, wherein the point of interest information comprises at least one of review information, business type information, name information, location information, travel route information, contact information, or business information of the corresponding point of interest.

17. A point of interest information crowd sourcing system comprising:
a plurality of user terminals; and
a server configured to perform communication with the plurality of user terminals,
wherein the server is configured to update a database for a point of interest stored in advance with point of interest information when receiving the point of interest information from at least one user terminal of the plurality of user terminals and information comprising an identification code assigned to a user of the at least one user terminal.
